(19) United States
(12) Patent Application Publication
(10) Pub. No.: US 2007/0104962 A1
(43) Pub. Date: May 10, 2007

(54) Hydrophillic polyisocyanate mixtures

(75) Inventors: Hans-Josef Laas, Odenthal (DE); Christian Wamprecht, Neuss (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/593,685

(22) Filed: Nov. 7, 2006

(30) Foreign Application Priority Data
Nov. 10, 2005 (DE) 102005053678.8

(51) Int. Cl. B32B 27/00; C08G 18/00; C08L 75/04

(52) U.S. Cl. 428/423.1; 525/452; 525/453

(57) ABSTRACT

The invention relates to new hydrophilic polyisocyanate mixtures based on polyacrylate-modified polyisocyanates, to a process for preparing them and to their use as a starting component in the production of polyurethane plastics, particularly as crosslinkers for water-soluble or water-dispersible film-forming binders or binder components containing groups that are reactive towards isocyanate groups.

### CROSS-REFERENCE TO RELATED APPLICATION

This application claims priority under 35 U.S.C. § 119 (a-d) to German application DE 102005 053 678.6, filed Nov. 10, 2005.

### FIELD OF THE INVENTION

The invention relates to new hydrophilic polyisocyanate mixtures based on polyacrylate-modified polyisocyanates, to a process for preparing them and to their use as a starting component in the production of polyurethane plastics, particularly as crosslinkers for water-soluble or water-dispersible film-forming binders or binder components containing groups that are reactive towards isocyanate groups.

### BACKGROUND OF THE INVENTION

Against the background of increasingly stringent environmental legislation, water-dispersible polyisocyanates gained importance in recent years for a variety of application fields. Today they find use in particular as crosslinker components for high-quality water-thinnable two-component-polyurethane (2K PU) coating materials or as adjuvants for aqueous dispersion adhesives, serve for crosslinking aqueous dispersions in textile finishing or formaldehyde-free textile printing inks, and are also suitable, furthermore, as, for example, wet-strength auxiliaries for paper (cf. e.g. EP-A 0 959 087 and references cited therein).

For the preparation of water-dispersible polyisocyanates there are a multiplicity of different processes known, examples being the reaction of hydrophobic polyisocyanates with hydrophilic polyether alcohols (see e.g. EP-B 0 206 059, EP-B 0 540 985 and EP-B 0 959 087), blending and/or reaction with specific hydrophilic polyether urethanes (see e.g. EP-B 0 486 881 and WO 2005/047357), reaction with compounds containing ionic groups (see e.g. WO 01/88006) or simple blending of hydrophobic polyisocyanates with suitable emulsifiers that are inert towards isocyanate groups (see e.g. WO 97/31960).

In spite of their broad market acceptance for a very wide variety of applications, the hydrophilically modified polyisocyanates presently available have disadvantages. Irrespective of the type of modification, the polyisocyanates employed predominantly at present in aqueous 2K PU coating materials are water-dispersible polyisocyanates based on 1,6-diisocyanatohexane (HDI). Even at low temperatures these polyisocyanates generally lead to coatings which have good resistance properties with respect to chemical and mechanical exposure, but which exhibit a drying rate which in many cases is inadequate, and comparatively low ultimate hardnesses. Hydrophilic HDI-polyisocyanates are therefore employed frequently in combination with appropriately modified polyisocyanates based on isophorone diisocyanate (IPDI) (see e.g. WO 2004/022623 and WO 2004/022624). This makes it possible to give considerable acceleration to the drying of the coating films and particularly to the development of hardness. For complete chemical crosslinking, nevertheless, IPDI polyisocyanates require temperatures in the region of 100° C. or more. At room temperature or with gently forced drying (about 60° C.) the coating films obtained are indeed quick to reach touch-dry and hard, but have a lower solvent resistance and chemical resistance than coatings crosslinked exclusively with HDI polyisocyanates.

It was an object of the present invention, therefore, to provide new hydrophilically modified polyisocyanates which suit all of the application fields of water-dispersible polyisocyanates, particularly as crosslinker components for aqueous polyurethane coating materials, but which are not hampered by the disadvantages of the prior art.

### SUMMARY OF THE INVENTION

This object has now been achieved with the provision of the hydrophilic polyisocyanate mixtures described in more detail below.

The present invention is based on the surprising observation that hydrophilically modified polyisocyanates based on innovative polyisocyanates containing polyacrylate structures stand out relative to the known hydrophilic HDI polyisocyanates by a sharp improvement in physical drying and at the same time, in contrast to the known hydrophilic IPDI polyisocyanates, crosslink fully even under mild curing conditions to give coating films with very high solvent resistance and chemical resistance.

The invention provides hydrophilic polyisocyanate mixtures comprising
A) at least one polyisocyanate containing at least one structural unit of the formula (I) 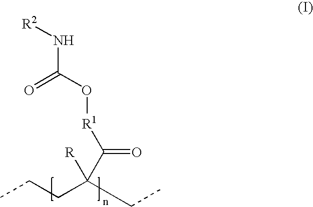
   where
R is hydrogen or a methyl group,
R¹ is an optionally heteroatom-containing hydrocarbon radical with up to 22 carbon atoms and
R² is a hydrocarbon radical containing at least one isocyanate group and in addition, optionally, urethane, allophanate, biuret, uretdione, isocyanurate and/or iminooxadiazinedione units and
n is an integer from 1 to 100,
   and
B) optionally further, non-A) polyisocyanates containing aliphatically, cycloaliphatically, aromatically and/or araliphatically attached isocyanate groups
   and
C) at least one ionic and/or nonionic emulsifier.

The invention further provides for the use of the hydrophilic polyisocyanate mixtures as a starting component in the production of polyurethane plastics, in particular as a crosslinker component for water-soluble or water-dispersible film-forming binders or film-forming binder components.

### DETAILED DESCRIPTION OF THE INVENTION

The hydrophilic polyisocyanate mixtures of the invention contain in one preferred embodiment as component A) at least one polyacrylate-modified polyisocyanate having an NCO content of 5% to 25% by weight, preferably of 7% to 22% by weight, an average NCO functionality ≧2, preferably from 2.2 to 6.0, and a viscosity at 23° C. of 150 to 200 000 mPa·s. These specific polyisocyanates A) contain a structural unit of the formula (I) 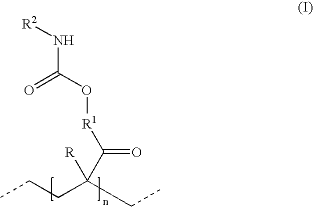
where
R is hydrogen or a methyl group,
R¹ is an optionally heteroatom-containing hydrocarbon radical with up to 22 carbon atoms and
R² is a hydrocarbon radical containing at least one isocyanate group and in addition, optionally, urethane, allophanate, biuret, uretdione, isocyanurate and/or iminooxadiazinedione units and
n is an integer from 1 to 100.

The preparation of polyacrylate-modified polyisocyanates of this kind is known. It takes place, as described in DE0456849, unpublished at the priority date of the present specification, by reaction of some of the isocyanate groups of a starting polyisocyanate A1) with at least one monoalcohol A2) containing acrylate and/or methacrylate groups, with urethanization, and subsequent polymerization—or polymerization initiated free-radically even during the urethanization reaction—of the unsaturated groups of the resultant reaction product in the manner of a homopolymerization or copolymerization with optionally further unsaturated monomers.

Suitable starting polyisocyanates A1) for preparing the polyacrylate-modified polyisocyanates A) are, for example, any desired monomeric diisocyanates and triisocyanates obtainable by phosgenation or by phosgene-free processes, such as by thermal urethane cleavage, for example. Preferred diisocyanates are those of the molecular weight range from 140 to 400 g/mol containing aliphatically, cycloaliphatically, araliphatically and/or aromatically attached isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 2,4- and 2,6-diisocyanato-1-methylcyclohexane, 1,3- and 1,4-bis(isocyanatomethyl)cyclohexane, 1-isocyanato-3,3,5-trimethyl-5-isocya-natomethylcyclohexane (isophorone diisocyanate, IPDI), 4,4′-diisocyanato-dicyclohexylmethane, 2,4′-diisocyanatodicyclohexylmethane, 1-isocyanato-1-methyl-4(3)isocyanatomethylcyclohexane, bis(isocyanatomethyl)norbornane, 1,3- and 1,4-bis(2-isocyanatoprop-2-yl)benzene (TMXDI), 2,4- and 2,6-diisocyanato-toluene (TDI), 2,4′- and 4,4′-diisocyanatodiphenylmethane (MDI), 1,5-diisocyanatonaphthalene or any desired mixtures of such diisocyanates. A monomeric triisocyanate particularly suitable as starting polyisocyanate A1) is, for example, 4-isocyanatomethyl-1,8-diisocyanatooctane.

Suitable starting polyisocyanates A1) for preparing the polyacrylate-modified polyisocyanates A) are also, however, any desired polyisocyanates obtainable by modifying the aforesaid aliphatic, cycloaliphatic, araliphatic and/or aromatic diisocyanates, these polyisocyanates being synthesized from at least two diisocyanates and having a uretdione, isocyanurate, allophanate, biuret, iminooxadiazinedione and/or oxadiazinetrione structure, of the kinds described exemplarily in, for example, J. Prakt. Chem. 336 (1994) 185-200 and EP-A 0 798 299.

The starting components A1) are preferably polyisocyanates of the aforesaid kind containing exclusively aliphatically and/or cycloaliphatically attached isocyanate groups, and having an average NCO functionality of 2.0 to 5.0, preferably of 2.3 to 4.5, an isocyanate group content of 8.0% to 27.0% by weight, preferably 14.0% to 24.0% by weight, and a monomeric diisocyanate content of less than 1% by weight, preferably less than 0.5% by weight.

Especially preferred starting components A1) are polyisocyanates of the aforementioned kind with an isocyanurate structure that are based on HDI, IPDI and/or 4,4′-diisocyanatodicyclohexylmethane.

To prepare the polyacrylate-modified polyisocyanates A) the aforesaid starting polyisocyanates A1) are reacted with suitable unsaturated monoalcohols A2). These are, for example, the known hydroxy-functional esters of acrylic and/or methacrylic acid, such as hydroxyethyl acrylate, hydroxyethyl methacrylate, hydroxypropyl acrylate (isomer mixture formed in the addition reaction of propylene oxide with acrylic acid), hydroxypropyl methacrylate (isomer mixture formed in the addition reaction of propylene oxide with methacrylic acid) and butanediol monoacrylate.

Other suitable monoalcohols A2) are the reaction products of the aforementioned hydroxy esters of acrylic or methacrylic acid with different amounts of cyclic lactones or monoexpoxides, a cyclic lactone employed being preferably ε-caprolactone and preferred monoexpoxides employed being ethylene oxide, propylene oxide or mixtures thereof.

Additionally, reaction products of glycidyl acrylate or glycidyl methacrylate with any desired monocarboxylic acids, or reaction products of acrylic or methacrylic acid with any desired monoepoxides, are suitable as hydroxy-functional component A2).

Besides these acrylate- and methacrylate-functional monoalcohols it is also possible, finally, to use allyl alcohol or its alkoxylation products as monoalcohols A2), such as mono-, di- or polyethoxylated allyl alcohol.

Preferred monoalcohols A2) for preparing the polyacrylate-modified polyisocyanates A), though, are the aforesaid acrylate- and methacrylate-functional monoalcohols or any desired mixtures of these compounds.

In one embodiment, not preferred, it is also possible to use mixtures of the abovementioned monoalcohols with non-OH-functional acrylates.

The reaction of the starting polyisocyanates A1) with the unsaturated monoalcohols A2) can take place solventlessly or optionally in a suitable solvent which is inert towards isocyanate groups. Examples of suitable solvents are the typical paint solvents that are known per se, such as ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, aromatics with relatively high levels of substitution, of the kind on the market, for example, under the names Solvent naphtha, Solvesso®, Isopar®, Nappar® (Deutsche EXXON CHEMICAL GmbH, Cologne, Del.) and Shellsol® (Deutsche Shell Chemie GmbH, Eschborn, Del.), carbonic esters, such as dimethyl carbonate, diethyl carbonate, 1,2-ethylene carbonate and 1,2-propylene carbonate, lactones, such as β-propiolactone, γ-butyrolactone, ε-caprolactone and ε-methylcaprolactone, and also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

In the initial urethanization A1) and A2) are reacted with one another in a proportion such that only some of the NCO groups of A1) are consumed. The amount of component A2) employed is preferably such that not more than 40 mol %, preferably not more than 30 mol %, more preferably not more than 25 mol % and very preferably not more than 20 mol %, based on the isocyanate groups of the starting polyisocyanates A1), are converted into urethane groups.

The urethanization takes place even at room temperature (23° C.) but if desired can also be carried out at lower or higher temperatures. In order to accelerate the reaction it is also possible to carry out the reaction at temperatures up to 160° C.

In order to accelerate the urethanization reaction it is, however, optionally possible, when preparing the polyacrylate-modified polyisocyanates A), to use, additionally, the typical catalysts known from polyurethane chemistry, examples being tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(III) chloride, aluminium tri(ethyl acetoacetate), zinc chloride, zinc(II) n-octanoate, zinc(II) 2-ethyl-1-hexanoate, zinc(II) 2-ethylcaproate, zinc(II) stearate, zinc(II) naphthenate, zinc(II) acetylacetonate, tin(II) n-octanoate, tin(II) 2-ethyl-1-hexanoate, tin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, bismuth 2-ethyl-1-hexanoate, bismuth octoate, molybdenum glycolate or any desired mixtures of such catalysts. Subsequent to the urethanization reaction, or, less preferably, while that reaction is still ongoing, the unsaturated groups of the reaction product are brought to reaction by a free-radically initiated (co)polymerization.

Suitable initiators for the polymerization of the unsaturated groups of the urethanization products of A1) and A2) are typical, azo- or peroxide-based free-radical initiators, but only those possessing a half-life which is sufficiently long for the polymerization in the temperature range stated below, namely a half-life of approximately 5 seconds to approximately 60 minutes. Suitable examples includes azodiisobutyronitrile, azobis-2-methylvaleronitrile, 2,2′-azobis(2-methylpropanenitrile), 2,2′-azobis(2-methylbutanenitrile), 1,1′-azobis(cyclohexanecarbonitrile), symmetrical diacyl peroxides, such as acetyl, propionyl or butyryl peroxide, with bromo-, nitro-, methyl- or methoxy-substituted benzoyl peroxides, lauryl peroxides; peroxydicarbonates, such as diethyl, diisopropyl, dicyclohexyl and dibenzoyl peroxydicarbonate, tert-butyl peroxyisopropyl carbonate, tert-butyl peroxy-2-ethylhexanoate, tert-butyl peroxy-3,5,5-trimethylhexanoate, tert-butyl perbenzoate, tert-butyl peroxydiethylacetate, tert-butyl peroxyisobutyrate, hydroperoxides, such as tert-butyl hydroperoxide, cumene hydroperoxide, dialkyl peroxides, such as dicumyl peroxide tert-butyl cumyl peroxide, di-tert-butyl peroxide, di-tert-amyl peroxide, 1,1-di-tert-butyl peroxy-3,3,5-trimethylcyclohexane or 1,1-di-tert-butylperoxycyclohexane.

The initiators are employed in amounts of 0.05% to 15% by weight, preferably 0.1 to 10% by weight, in particular 0.2% to 8% by weight, based on the total amount of the monoalcohols A2) employed.

In general the polymerization takes place in the temperature range from 50 to 240° C., preferably 60 to 220° C. and more preferably 70 to 200° C. This polymerization can be carried out under a pressure of up to 15 bar.

In order to carry out the polymerization reaction the urethane-modified polyisocyanate mixture obtained by reaction of A1) with A2) is heated to the desired polymerization temperature. The free-radical initiator is then metered into the reaction mixture, and the free-radical polymerization initiated by decomposition of the free-radical initiator is carried out at the set polymerization temperature. In the course of the polymerization reaction it is also possible optionally to alter the temperature in order to set specific molecular weight distributions. After the end of the polymerization the reaction mixture is cooled to room temperature and the polyacrylate-modified polyisocyanates A) are obtained in the form of pale-coloured viscous liquids or, if additionally using solvents, of corresponding solutions.

The hydrophilic polyisocyanate mixtures of the invention optionally comprise further, non-A) polyisocyanates B) containing aliphatically, cycloaliphatically, aromatically and/or araliphatically attached isocyanate groups. These polyisocyanates are the low-monomer content polyisocyanates described above as suitable components A1), which are obtainable by modifying the corresponding diisocyanates and which have a uretdione, isocyanurate, allophanate, biuret, iminooxadiazinedione and/or oxadiazinetrione structure, or any desired mixtures of such polyisocyanates. The polyisocyanates B) for optionally additional use are preferably the aforesaid polyisocyanates containing exclusively aliphatically and/or cycloaliphatically attached isocyanate groups, very preferably polyisocyanates with an isocyanurate structure based on HDI, IPDI and/or 4,4′-diisocyanatodicyclohexylmethane.

The hydrophilic polyisocyanate mixtures of the invention comprise at least one ionic and/or nonionic emulsifier C).

C) comprises any desired surface-active compounds which on the basis of their molecular structure are capable of stabilizing polyisocyanates or polyisocyanate mixtures in aqueous emulsions over a prolonged period.

Suitable nonionic emulsifiers are reaction products C1) of polyisocyanates corresponding to those of components A) and/or B) with hydrophilic polyether alcohols.

Suitable hydrophilic polyether alcohols are monofunctional or polyfunctional polyalkylene oxide polyether alcohols, containing on average 5 to 50 ethylene oxide units per molecule, of the kind obtainable conventionally by alkoxylating suitable starter molecules (see e.g. Ullmanns Encyclopädie der technischen Chemie, 4th Edition, Volume 19, Verlag Chemie, Weinheim pp. 31-38). Starter molecules of this kind may for example be any desired monohydric or polyhydric alcohols of the molecular weight range 32 to 300 g/mol, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methyl-cyclohexanols, hydroxymethylcyclohexane, 3-methyl-3-hydroxymethyloxetane, benzyl alcohol, phenol, the isomeric cresols, octylphenols, nonylphenols and naphthols, furfuryl alcohol, tetrahydrofurfuryl alcohol, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)isocyanurate.

Alkylene oxides suitable for the alkoxylation reaction are, in particular, ethylene oxide and propylene oxide, which can be used in any order or else in a mixture for the alkoxylation reaction. Suitable polyether alcohols are either pure polyethylene oxide polyether alcohols or mixed polyalkylene oxide polyethers at least 70 mol %, preferably at least 80 mol %, of whose alkylene oxide units are composed of ethylene oxide units.

Preferred polyalkylene oxide polyether alcohols are those prepared using the abovementioned monoalcohols of the molecular weight range 32 to 150 g/mol as starter molecules. Particularly preferred polyether alcohols are pure polyethylene glycol monomethyl ether alcohols containing on average 5 to 50, very preferably 5 to 25 ethylene oxide units.

The preparation of nonionic emulsifiers of this kind is known in principle and described for example in EP-B 0 206 059 and EP-B 0 540 985.

The preparation can take place by reaction of polyisocyanates corresponding to those of polyisocyanate components A) and/or B) with the aforesaid polyether alcohols either in a separate reaction step with subsequent mixing with the polyisocyanate components A) and optionally B) for conversion into a hydrophilic form, or else by blending the polyisocyanate components A) and optionally B) with a corresponding amount of the polyether alcohols, accompanied by spontaneous formation of a hydrophilic polyisocyanate mixture of the invention which as well as unreacted acrylate-modified polyisocyanate A) and optionally further polyisocyanates B) contains the emulsifier C1) that forms in situ from the polyether alcohol and a part of the components A) and optionally B).

The preparation of this kind of nonionic emulsifier C1) takes place in general at temperatures from 40 to 180° C., preferably 50 to 150° C., observing an NCO/OH equivalent ratio of 2:1 to 400:1, preferably of 4:1 to 140:1.

In the case of the first-mentioned variant of the separate preparation of the nonionic emulsifiers C1) they are prepared preferably observing an NCO/OH equivalent ratio of 2:1 to 6:1. In the case of the preparation of emulsifiers C1) in situ it is of course possible for a large excess of isocyanate groups, within the broad range stated above, to be employed.

The reaction of the polyisocyanates with the aforesaid hydrophilic polyether alcohols to give nonionic emulsifiers C1) can also be carried out, in accordance with the process described in EP-B 0 959 087, in such a way that at least a proportion, preferably at least 60 mol %, of the urethane groups formed primarily by NCO/OH reaction are reacted further to form allophanate groups. In this case reactants are reacted in the abovementioned NCO/OH equivalent ratio at temperatures from 40 to 180° C., preferably 50 to 150° C., generally in the presence of the catalysts suitable for accelerating the allophanatization reaction that are set out in the cited patents.

A further type of suitable nonionic emulsifier C) is also represented, for example, by reaction products of monomeric diisocyanates or diisocyanate mixtures with the aforesaid monofunctional or polyfunctional hydrophilic polyether alcohols, with an NCO/OH ratio of 1:1, in particular with pure polyethylene glycol monomethyl ether alcohols containing on average 5 to 50, preferably 5 to 25 ethylene oxide units. The preparation of emulsifiers C2) of this kind is likewise known and described for example in EP-B 0 486 881.

Optionally, however, it is also possible to react the polyether urethane emulsifiers C2), after blending of the components in the proportions described above, in the presence of suitable catalysts with the acrylate-modified polyisocyanates A) and optionally further polyisocyanates B), with allophanatization. This produces likewise hydrophilic polyisocyanate mixtures of the invention, which as well as unreacted acrylate-modified polyisocyanate A) and optionally further polyisocyanates B) contain a further nonionic emulsifier type C3) with allophanate structure that is formed in situ from the emulsifier C2) and a part of the components A) and optionally B). The preparation of such emulsifiers C3) in situ is also already known and described for example in WO 2005/047357.

Instead of the nonionic emulsifiers described by way of example, the hydrophilic polyisocyanate mixtures of the invention may also comprise emulsifiers containing ionic groups, especially anionic groups.

Such ionic emulsifiers C) represent emulsifiers C4) containing sulphonate groups, as are obtainable, for example, by the process of WO 01/88006, by reacting polyisocyanates corresponding to those of polyisocyanate components A) and/or B) with 2-(cyclohexylamino)ethanesulphonic acid and/or 3-(cyclohexylamino)propanesulphonic acid. This reaction takes place in general at temperatures of 40 to 150° C., preferably 50 to 130° C., observing an equivalent ratio of NCO groups to amino groups of 2:1 to 400:1, preferably 4:1 to 250:1, and using tertiary amines as well to neutralize the sulphonic acid groups. Examples of suitable neutralizing amines are tertiary monoamines, such as trimethylamine, triethylamine, tripropylamine, tributylamine, dimethylcyclohexylamine, diisopropylethylamine, N-methylmorpholine, N-ethylmorpholine, N-methylpiperidine, or N-ethylpiperidine, tertiary diamines, such as 1,3-bis(dimethylamino)propane, 1,4-bis(dimethylamino)butane or N,N′-dimethylpiperazine, or, albeit less preferably, alkanolamines, such as dimethylethanolamine, methyldiethanolamine or triethanolamine.

As already described for the nonionic emulsifiers C1), the preparation of these ionic emulsifiers C4) can also take place either in a separate reaction step with subsequent mixing with the polyisocyanate component A) and optionally B) for conversion into a hydrophilic form, or else in situ within these polyisocyanate components, in which case a hydrophilic polyisocyanate mixture according to the invention is formed directly that contains not only unreacted acrylate-modified polyisocyanate A) and optionally further polyisocyanates B) but also the emulsifier C4) which forms in situ from the aminosulphonic acids, the neutralizing amine and a part of components A) and optionally B).

Another type of suitable emulsifier C) is that containing ionic and nonionic structures simultaneously in one molecule. These emulsifiers, C5), are, for example, alkylphenol polyglycol ether phosphates and phosphonates or fatty alcohol polyglycol ether phosphates and phosphonates, neutralized with tertiary amines, such as the neutralizing amines specified above, and are of the kind described in, for example, WO 97/31960 for hydrophilicizing polyisocyanates, or else are alkylphenol polyglycol ether sulphates or fatty alcohol polyglycol ether sulphates neutralized with tertiary amines of the aforesaid kind.

Irrespective of the nature of the emulsifier C) and its preparation, the amount of emulsifier, or the amount of the ionic and/or nonionic components added to the acrylate-modified polyisocyanates A) and optionally further polyisocyanates B) in the case of in situ preparation of the emulsifier, is such that the hydrophilic polyisocyanate mixtures of the invention that are ultimately obtained contain an amount which ensures the dispersibility of the polyisocyanate mixture, preferably 1% to 50% by weight, more preferably 2% to 30% by weight, based on the total amount of components A) to C).

The hydrophilic polyisocyanate mixtures of the invention are clear, virtually colourless products of the aforementioned composition, which optionally may also be present in a form in which they are in solution in solvents, such as the typical paint solvents specified above. As a general rule they can be converted readily, without using high shearing forces, into sedimentation-stable dispersions, by simply stirring them into water.

The invention further provides hydrophilicized polyisocyanates based on aromatic, araliphatic, cycloaliphatic and/or aliphatic polyisocyanates having an NCO content of 5% to 25% by weight, an NCO functionality ≧2, a viscosity in solvent-free state of 150 to 200 000 mPa·s at 23° C., measured with a rotational viscometer to DIN 53019, wherein they contain at least one structural unit of the formula (I) 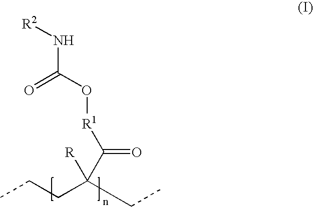
where
R is hydrogen or a methyl group,
R¹ is an optionally heteroatom atom-containing hydrocarbon radical with up to 22 carbon atoms and
R² is a hydrocarbon radical containing at least one isocyanate group and additionally, optionally, urethane, allophanate, biuret, uretdione, isocyanurate and/or iminooxadiazinedione units and
n is a number from 1 to 100
and additionally
polyether units of the formula (II) 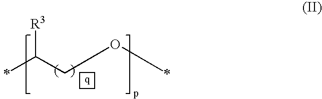
   where
R³ is hydrogen or a C1 to Clo alkyl radical and
p is a number between 1 to 1000, and
q is 1 to 3
and/or sulphonate groups (as SO₃)
and/or phosphate groups (as PO₄)

Preferably R³ is hydrogen or a methyl groups and p is 1 to 300.

The polyethers of the formula (II) are preferably attached by urethane groups to the polyisocyanate skeleton.

The NCO groups of the hydrophilic polyisocyanate mixtures of the invention can of course also be used in a form in which they are blocked with blocking agents known per se from polyurethane chemistry, in combination with the abovementioned aqueous film-forming binders or film-forming binder components, as aqueous one-component PU baking systems. Examples of suitable blocking agents include diethyl malonate, ethyl acetoacetate, acetone oxime, butanone oxime, ε-caprolactam, 3,5-dimethylpyrazole, 1,2,4-triazole, dimethyl-1,2,4-triazole, imidazole, diisopropylamine, dicyclohexylamine, N-tert-butylbenzylamine cyclopentanone-2-carboxymethyl ester, cyclopentanone-2-carboxyethyl ester or any desired mixtures of these blocking agents.

The invention further provides a process for preparing hydrophilic polyisocyanate mixtures of the abovementioned kind, wherein the polyisocyanate components A) and optionally B) is mixed with an ionic and/or nonionic emulsifier C) and/or an emulsifier of said kind is generated in situ by reacting the polyisocyanate components A) and optionally B) with hydrophilic, isocyanate-reactive ionic and/or nonionic compounds, the amounts of the starting components being chosen, irrespective of the preparation process, such that the emulsifier is present in an amount of 2% to 60% by weight, based on the total amount of components A) to C).

The outstanding dispersibility in compounds with the polyacrylate modification of the starting polyisocyanates A) constitutes an advantage in particular for the use of the hydrophilic polyisocyanates of the invention in aqueous 2K PU coating materials, since it allows highly crosslinked coatings to be obtained which are notable for very short cure times. Owing to the more rapid initial physical drying and simultaneously rapid chemical crosslinking as compared with the existing hydrophilic, non-polyacrylate-modified polyisocyanates, service articles coated using the polyisocyanate mixtures of the invention exhibit sufficient resistance to solvents and chemicals much earlier, and can be taken into service earlier. The coating films obtainable using the hydrophilic polyisocyanate mixtures of the invention are notable, in addition, for a high level of hardness and elasticity, excellent weathering resistance and chemical resistance, and also high gloss.

Optionally it is possible to add further, non-hydrophilicized polyisocyanates, especially paint polyisocyanates of the type specified above under B), to the hydrophilic polyisocyanate mixtures of the invention, prior to emulsification, the proportions being chosen preferably such that the resultant polyisocyanate mixtures likewise represent hydrophilic polyisocyanate mixtures of the invention, since these are generally composed of mixtures of
(i) polyisocyanate mixtures hydrophilically modified in accordance with the invention and
(ii) unmodified polyisocyanates of the type exemplified.

In mixtures of this kind the hydrophilic polyisocyanate mixtures of the invention take on the function of an emulsifier for the subsequently admixed fraction of non-hydrophilic polyisocyanates.

The hydrophilic polyisocyanate mixtures of the invention are valuable starting materials for production of polyurethane plastics by the isocyanate polyaddition process.

The invention hence also provides coating compositions comprising the hydrophilicized polyacrylate-modified polyisocyanate mixtures of the invention.

In these coating compositions the hydrophilic polyisocyanate mixtures are used preferably in the form of aqueous emulsions, which in combination with unblocked polyhydroxyl compounds in dispersion in water can be reacted as aqueous two-component systems, or in a form in which they are blocked with blocking agents of the aforementioned kind can be reacted as aqueous one-component systems.

With particular preference the hydrophilic polyisocyanate mixtures of the invention are used as crosslinkers for film-forming binders or film-forming binder components which are in aqueous solution or dispersion and contain groups that are reactive towards isocyanate groups, particularly alcoholic hydroxyl groups, in the production of coatings using aqueous coating compositions based on binders or binder components of this kind. The uniting of the crosslinker, optionally in emulsified form, with the binders or binder components can be brought about in this case by simple stirring together, prior to the processing of the coating compositions in accordance with any desired methods; by using mechanical assistants known to the skilled person; or else using two-component spray guns.

Suitable in principle as reactants for the polyisocyanate mixtures of the invention are all binders in aqueous solution or dispersion that contain isocyanate-reactive groups.

In this connection, the following may be mentioned by way of example as film-forming binders or film-forming binder components: aqueous solutions or dispersions of hydroxyl-containing polyacrylates, particularly those of the molecular weight range 1000 to 10 000 g/mol, which with organic polyisocyanate crosslinkers constitute valuable two-component binders, or aqueous dispersions of optionally urethane-modified, hydroxyl-containing polyester resins of the kind known from polyester and alkyd resin chemistry. The binders also include, for example, aqueous dispersions of polyurethanes or polyureas which are crosslinkable with polyisocyanates by virtue of the active hydrogen atoms present in the urethane or urea groups, respectively.

In the context of inventive use as a crosslinker component for aqueous film-forming binders, the hydrophilic polyisocyanate mixtures of the invention are generally employed in amounts corresponding to an equivalent ratio of NCO groups to NCO-reactive groups, especially alcoholic hydroxyl groups, of 0.5:1 to 2:1.

Optionally it is possible for the hydrophilic polyisocyanate mixtures of the invention to be mixed in minor amounts into non-functional aqueous film-forming binders for the purpose of obtaining very specific properties—for example, as an adhesion promoter additive.

Substrates suitable for the aqueous coatings formulated using the hydrophilic polyisocyanate mixtures of the invention include any desired substrates, such as metal, wood, glass, stone, ceramic materials, concrete, rigid and flexible plastics, textiles, leather and paper, which prior to coating may also be provided optionally with typical primers.

Generally speaking, the aqueous coating compositions which are formulated with the coating compositions of the invention and to which it is possible optionally to add the auxiliaries and adjuvants that are typical in the coatings sector, such as flow control assistants, colour pigments, fillers, matting agents or emulsifiers, for example, possess good technical film properties even on room temperature drying.

They can of course also be dried, however, under forced conditions at elevated temperature or by baking at temperatures up to 260° C.

Besides their preferred use as crosslinker components for aqueous 2K PU coating materials, the hydrophilic polyisocyanate mixtures of the invention are also outstandingly suitable as crosslinkers for aqueous dispersion adhesives, leather coatings and textile coatings or textile printing pastes, as AOX-free papermaking assistants or else as adjuvants for mineral building materials, such as concrete or mortar compounds, for example.

### EXAMPLES

All percentages below are by weight unless otherwise noted.

The characteristic data reported were determined by the following methods:
Viscosity: rotational of viscometer VT 550 from Haake GmbH, Karlsruhe, Del., MV-DIN cup for viscosity <10 000 mPa·s/23° C., SV-DIN cup for viscosity >10 000 mPa·s/23° C.
NCO content: back-titration with 1 mol/l HCl after reaction with excess dibutylamine in acetone, based on DIN EN ISO 11909
Hazen colour number: Hazen colour number to DIN 53995, Lico® 400 colour number measuring instrument, Dr. Lange GmbH, Berlin, Del.
   Preparation of Polyacrylate-Modified Polyisocyanates A)
   Starting Polyisocyanates A1)
Desmodur N 3300: polyisocyanate based on HDI and containing isocyanurate groups, solvent-free, NCO content 21.8%, viscosity: 3000 mPa·s/23° C. (Bayer MaterialScience AG, Leverkusen, Del.).
Desmodur® N 3600: polyisocyanate based on HDI and containing isocyanurate groups, solvent-free, NCO content 23.0%, viscosity: 1200 mPa·s/23° C. (Bayer MaterialScience AG, Leverkusen, Del.).
Desmodur® XP 2410: polyisocyanate based on HDI and containing iminooxadiazinedione groups, solvent-free, NCO content 23.7%, viscosity: 700 mPa·s/23° C. (Bayer MaterialScience AG, Leverkusen, Del.).
   Unsaturated Monoalcohols A2)
HEA: hydroxyethyl acrylate
HEMA: hydroxyethyl methacrylate
   Polymerization Initiator
Peroxan® PO 49B: tert-butyl peroxy-2-ethylhexanoate, 49% strength in butyl acetate (Pergan GmbH, Bocholt, Del.)
   General Operating Instructions

A 1-liter three-necked flask with stirrer, reflux condenser and dropping funnel was charged with the respective starting polyisocyanate A1), optionally with butyl acetate as solvent, and this initial charge was heated to 130° C. under a nitrogen atmosphere. Then the unsaturated monoalcohol A2) was metered in over the course of 10 minutes, followed by a further stirring at 130° C. for 1 hour, before the desired polymerization temperature (T) was set. When this temperature was reached the polymerization initiator, generally Peroxan® PO 49B, was added in one portion and the mixture was stirred at the set polymerization temperature for 1 hour. It was then cooled to room temperature, giving pale-coloured, viscous polyisocyanates A).

Polyacrylate-Modified Polyisocyanate A (1)

In accordance with the general operating instructions, 95.5 parts by weight Desmodur® N 3300 were reacted solventlessly with 4.3 parts by weight of HEMA and the product was then polymerized by means of 0.2 part by weight of Peroxan® PO 49B at 130° C. This gave a colourless polyisocyanate having a solids content of 100% by weight, a viscosity (23° C.) of 12 500 mPa·s, an isocyanate content of 20.4% by weight and a colour number of 11 APHA.

Polyacrylate-Modified Polyisocyanate A (II)

In accordance with the general operating instructions, 97.0 parts by weight Desmodur® N 3600 were reacted solventlessly with 2.85 parts by weight of HEA and the product was then polymerized by means of 0.15 part by weight of Peroxan® PO 49B at 130° C. This gave a colourless polyisocyanate having a solids content of 100% by weight, a viscosity (23° C.) of 3700 mPa·s, an isocyanate content of 21.1% by weight and a colour number of 11 APHA.

Polyacrylate-Modified Polyisocyanate A (III)

In accordance with the general operating instructions, 96.0 parts by weight Desmodur® N 3600 were reacted solventlessly with 3.8 parts by weight of HEA and the product was then polymerized by means of 0.2 part by weight of Peroxan® PO 49B at 100° C. This gave a colourless polyisocyanate having a solids content of 100% by weight, a viscosity (23° C.) of 12 300 mPa·s, an isocyanate content of 20.5% by weight and a colour number of 10 APHA.

Polyacrylate-Modified Polyisocyanate A (IV)

In accordance with the general operating instructions, 95.5 parts by weight Desmodur® N 3600 were reacted solventlessly with 4.3 parts by weight of HEMA and the product was then polymerized by means of 0.2 part by weight of Peroxan® PO 49B at 130° C. This gave a colourless polyisocyanate having a solids content of 100% by weight, a viscosity (23° C.) of 6700 mPa·s, an isocyanate content of 20.5% by weight and a colour number of 11 APHA.

Polyacrylate-Modified Polyisocyanate A (V)

In accordance with the general operating instructions, 86.4 parts by weight Desmodur® XP 2410 were reacted in 5.0 parts by weight of butyl acetate with 3.4 parts by weight of HEA and the product was then polymerized by means of 0.2 part by weight of tert-butyl peroxy-2-ethylhexanoate in solution in 5.0 parts by weight of butyl acetate at 100° C. This gave a colourless solution of a polyisocyanate having a solids content of 90% by weight, a viscosity (23° C.) of 1180 mPa·s, an isocyanate content of 19.8% by weight and a colour number of 16 APHA.

### Example 1

### Inventive; Emulsifier C1

900 g (4.37 eq) of the polyacrylate-modified polyisocyanate A (I) were introduced as an initial charge at 100° C. under dry nitrogen and with stirring, admixed over the course of 30 minutes with 100 g (0.29 eq) of a monofunctional polyethylene oxide polyether prepared starting from methanol and having an average molecular weight of 350, and stirred further at this temperature until, after about 2 h, the NCO content of the mixture had fallen to the figure of 17.1% corresponding to complete urethanization. After cooling to room temperature, the characteristic data for the resultant hydrophilic polyisocyanate mixture of the invention were as follows:

Solids content: 100%

NCO content: 17.1%

Viscosity (23° C.): 14 800 mPas

### Example 2

### Inventive; Emulsifier C1

900 g (4.52 eq) of the polyacrylate-modified polyisocyanate A (II) were introduced as an initial charge at 100° C. under dry nitrogen and with stirring, admixed over the course of 30 minutes with 100 g (0.20 eq) of a monofunctional polyethylene oxide polyether prepared starting from methanol and having an average molecular weight of 500, and stirred further at this temperature until, after about 2 h, the NCO content of the mixture had fallen to the figure of 18.2% corresponding to complete urethanization. After cooling to room temperature, the characteristic data for the resultant hydrophilic polyisocyanate mixture of the invention were as follows:

Solids content: 100%

NCO content: 18.2%

Viscosity (23° C.): 4700 mPas

### Example 3

### Inventive; Emulsifier C1

900 g (4.52 eq) of the polyacrylate-modified polyisocyanate A (II) were introduced as an initial charge at 100° C. under dry nitrogen and with stirring, admixed over the course of 30 minutes with 100 g (0.20 eq) of the polyether alcohol described in Example 2, and stirred further at this temperature until, after about 2 h, the NCO content of the mixture had fallen to the figure of 18.2% corresponding to complete urethanization. After addition of 0.01 g of zinc(II) 2-ethyl-1-hexanoate as allophanatization catalyst, the heat of reaction liberated caused the temperature of the reaction mixture to rise to 105° C. After the exothermic heat had subsided, approximately 30 minutes after addition of the catalyst, the reaction was discontinued by addition of 0.01 g of benzoyl chloride and the reaction mixture was cooled to room temperature. This gave a hydrophilic polyisocyanate mixture of the invention having the following characteristic data:

Solids content: 100%

NCO content: 17.3%

Viscosity (23° C.): 12 600 mPas

### Example 4

### Inventive; Emulsifier C2

150 g (0.3 eq) of the polyether alcohol described in Example 2 were admixed with 80 g (0.3 eq) of a mixture of 80 parts 2,4-TDI and 20 parts 2,6-TDI and the mixture was stirred at 60° C. until isocyanate groups were no longer detectable by IR spectroscopy. After the mixture had cooled to 30° C., 1300 g of the polyacrylate-modified polyisocyanate A (I) were mixed in to give a hydrophilic polyisocyanate mixture of the invention having the following characteristic data:

Solids content: 100%

NCO content: 18.3%

Viscosity (23° C.): 13 500 mPas

### Example 5

### Inventive; Emulsifier C4

980 g (4.78 eq) of the polyacrylate-modified polyisocyanate A (III) were stirred at 80° C. under dry nitrogen for 5 hours together with 20 g (0.09 eq) of 3-(cyclohexylamino)propanesulphonic acid (CAPS), 11.5 g (0.09 mol) of dimethylcyclohexylamine and 253 g of 1-methoxyprop-2-yl acetate. Cooling to room temperature gave a virtually colourless, clear solution of a hydrophilic polyisocyanate mixture of the invention, having the following characteristic data:

Solids content: 80%

NCO content: 15.6%

Viscosity (23° C.): 1300 mPas

### Example 6

### Inventive; Emulsifier C4

950 g (4.64 eq) of the polyacrylate-modified polyisocyanate A (IV) were stirred at 80° C. under dry nitrogen for 5 hours together with 50 g (0.23 eq) of 3-(cyclohexylamino)propanesulphonic acid (CAPS), 29 g (0.23 mol) of dimethylcyclohexylamine and 257 g of 1-methoxyprop-2-yl acetate. Cooling to room temperature gave a virtually colourless, clear solution of a hydrophilic polyisocyanate mixture of the invention, having the following characteristic data:

Solids content: 80%

NCO content: 14.4%

Viscosity (23° C.): 1870 mPas

### Example 7

### Inventive; Emulsifier C4

1000 g (4.71 eq) of the polyacrylate-modified polyisocyanate A (V) were stirred at 80° C. under dry nitrogen for 5 hours together with 30 g (0.14 eq) of 3-(cyclohexylamino)propanesulphonic acid (CAPS), 18 g (0.14 mol) of dimethylcyclohexylamine and 5 g of butyl acetate. Cooling to room temperature gave a virtually colourless, clear solution of a hydrophilic polyisocyanate mixture of the invention, having the following characteristic data:

Solids content: 90%

NCO content: 18.2%

Viscosity (23° C.): 3400 mPas

### Example 8

### Comparative as Per EP-B 0 540 985; Emulsifier C1

870 g (4.52 eq) of the Desmodur® N 3300 were introduced as an initial charge at 100° C. under dry nitrogen and with stirring, admixed over the course of 30 minutes with 130 g (0.37 eq) of the polyether alcohol described in Example 1, and stirred further at this temperature until, after about 2 h, the NCO content of the mixture had fallen to the figure of 17.4% corresponding to complete urethanization. This gave, after cooling to room temperature, a colourless, clear polyisocyanate mixture having the following characteristic data:

Solids content: 100%

NCO content: 17.4%

Viscosity (23° C.): 3400 mPas

### Example 9

### Comparative as Per EP-B 0 540 985; Emulsifier C1

870 g (2.47 eq) of a polyisocyanate based on IPCI, containing isocyanurate groups and having an NCO content of 11.9%, in the form of a 70% strength solution in butyl acetate, with a viscosity of 600 mPas (23° C.) (Desmodur® 4470 BA, Bayer MaterialScience AG, Leverkusen, Del.) were introduced as an initial charge together with a further 391 g of butyl acetate at 100° C. under dry nitrogen and with stirring, and this initial charge was admixed over the course of 30 minutes with 91 g (0.26 eq) of the polyether alcohol described in Example 1 and then stirred further at this temperature until, after about 2.5 h, the NCO content of the mixture had fallen to the figure of 9.3% corresponding to complete urethanization.

After cooling to room temperature, 30 parts by weight of the clear polyisocyanate solution present were blended with 70 parts by weight of the polyisocyanate mixture from Comparative Example 8. The hydrophilic polyisocyanate mixture thus obtained had the following characteristic data:

Solids content: 91%

NCO content: 15.0%

Viscosity (23° C.): 2500 mPas

### Example 10

### Use as Crosslinker for Aqueous 2K PU Coating Materials; Inventive [a] and Comparative [b] and [c]

100 parts by weight of an aqueous, cosolvent-free, hydroxy-functional polyacrylate dispersion having a solids content of 43% and an OH content of 2.5%, based on solid resin, composed essentially of 48.0% of methyl methacrylate, 27.4% of n-butyl acrylate, 21.6% of hydroxy-C₃-alkyl methacrylate (adduct of propylene oxide with methacrylic acid) and 3.0% of acrylic acid are mixed with 0.5 part by weight of a commercially customary defoamer (Foamaster TCX, Henkel). The preparation has unlimited storage stability.

24.5 parts by weight of the polyisocyanate of the invention from Example 1 are added to the abovementioned batch (corresponding to an equivalent ratio of isocyanate groups to alcoholic hydroxyl groups of 1.5:1) and the batch is homogenized by intensive stirring (2000 rpm). Subsequently the solids content is adjusted to 40% by addition of water.

For the comparison, a coating material was prepared by the method described above from, respectively, 100 parts by weight of the above-described hydroxy-functional polyacrylate dispersion and 24.0 parts by weight of the polyisocyanate from Example 8 or 27.9 parts by weight of a mixture of the comparative polyisocyanates from Examples 8 and 9 in a ratio of 70:30%. The equivalent ratios of isocyanate groups to alcoholic hydroxyl groups were again 1.5:1.

The processing time of the coating materials in the ready-to-apply state was approximately 3 hours. The coating materials were applied in a wet film thickness of 150 μm (approximately 60 μm dry) to glass plates and flashed off for 20 minutes and then dried under forced conditions (30 minutes/60° C.). This gave coating films having the following properties:

| | | | EXAMPLE 10 | | |
|---|---|---|---|---|---|
| | | | [a] | [b] | [c] |
| | | | (inventive) | (comparative) | (comparative) |
| Polyisocyanate from | | | Example 1 | Example 8 | Example 9 |
| Gloss (20°) ^{a)} | | | 91 | 89 | 88 |
| Haze ^{b)} | | | 8.5 | 8.1 | 11 |
| Pendulum hardness ^{c)} | immediate/after | | 134/165 | 77/134 | 141/181 |
| [s] | 1 d | | | | |
| Drying ^{d)} | T3 [+min] | | 10 | 15 | 10 |
| | T4 [+min] | | 45 | 110 | 40 |
| Chip insertion ^{e)} | | | 0 | 1 | 3 |
| Solvent resistance ^{f)} | | | | | |
| Water | (30 | min.) | 0 | 0 | 0 |
| Isopropanol/water 1:1 | (1 | min.) | 0 | 0-1 | 2 |
| MPA/xylene 1:1 | (1 | min.) | 0 | 1 | 1 |
| Butyl glycol | (1 | min.) | 0 | 0-1 | 1 |
| Acetone | (1 | min.) | 1 | 1 | 3 |

^{a)} Gardner gloss (20° angle) (DIN 67530)
^{b)} Haze (DIN EN ISO 13803)
^{c)} König pendulum hardness (DIN 53157)
^{d)} Degree of drying (DIN 53150)
^{e)} Evaluation: 0-5 (0 = very good; 5 = poor)
^{f)} After 1 d; evaluation: 0-5 (0 = coating film unchanged; 5 = completely dissolved)

All three polyisocyanates give high-gloss coating films with very low haze levels. The coating material based on the inventively prepared hydrophilic polyisocyanate mixture from Example 1, however, dries considerably more quickly than the coating material crosslinked with the polyisocyanate from Comparative Example 8, prepared on the basis of the non-polyacrylate-modified HDI trimer, and at the same time also has a higher hardness and better solvent resistance. The use of the IPDI-containing polyisocyanate from Comparative Example 9, although likewise leading to rapid drying, nevertheless produces a brittle coating film with significantly lower solvent resistance.

### Example 11 to 14

### Use as Crosslinkers for Aqueous 2K PU Coating Materials; Inventive

In accordance with the process described in Example 10, clearcoat materials were prepared starting from the hydroxyl-containing polyacrylate dispersion described in Example 10 and also the hydrophilic polyisocyanate mixtures of the invention from Example 2, 3, 4 and 5. The equivalent ratio of NCO to OH groups was in all cases 1.5:1. The fully formulated coating materials were applied in a wet film thickness of 150 μm (approximately 60 μm dry) to glass plates and flashed off for 20 minutes and then dried under forced conditions (30 min/60° C.). The table below shows the compositions (parts by weight) of the coating materials and also the technical film data of the coatings obtained from them.

| | | | Example | | | |
|---|---|---|---|---|---|---|
| | | | 11 | 12 | 13 | 14 |
| Polyacrylate | Example 10 | | 100 | 100 | 100 | 100 |
| dispersion | | | | | | |
| from | | | | | | |
| Polyisocyanate | Example 2 | | 23.0 | — | — | — |
| from | Example 3 | | — | 24.1 | — | — |
| | Example 4 | | — | — | 22.8 | — |
| | Example 5 | | — | — | — | 26.8 |
| Foamaster TCX | | | 0.5 | 0.5 | 0.5 | 0.5 |
| Gloss (20°) ^{a)} | | | 90 | 90 | 89 | 88 |
| Haze ^{b)} | | | 8.2 | 8.0 | 8.5 | 10.5 |
| Pendulum | immediate/ | | 137/166 | 140/171 | 134/165 | 142/178 |
| hardness ^{c)} | 1 d | | | | | |
| [s] | | | | | | |
| Drying ^{d)} | T3 [+min] | | 10 | 5 | 15 | 0 |
| | T4 [+min] | | 40 | 35 | 45 | 30 |
| Solvent | | | | | | |
| resistance ^{f)} | | | | | | |
| Water | (30 | min.) | 0 | 0 | 0 | 0 |
| Isopropanol/ | (1 | min.) | 0 | 0 | 0-1 | 0 |
| water 1:1 | | | | | | |
| MPA/xylene 1:1 | (1 | min.) | 0 | 0 | 0-1 | 0 |
| Butyl glycol | (1 | min.) | 0 | 0 | 0-1 | 0 |
| Acetone | (1 | min.) | 1 | 0-1 | 1 | 0 |

^{a)} for evaluation see Example 10)

The hydrophilic polyisocyanate mixtures of the invention from Example 2 to 5, as crosslinker components for aqueous 2K PU coating materials, also exhibit the advantages in terms of hardness, solvent resistance and rapid drying already described in Example 10 for the hydrophilic polyisocyanate mixture of the invention from Example 1 (see Example 10 [a]), as compared with the non-polyacrylate-modified polyisocyanate crosslinkers from Comparative Example 8 and 9 (see Example 10 [b] and [c]).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Hydrophilic polyisocyanate mixtures comprising
A) at least one polyisocyanate containing at least one structural unit of the formula (I) 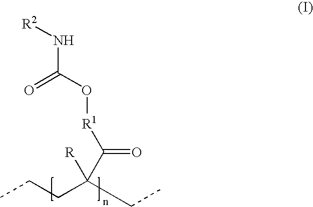
where
R is hydrogen or a methyl group,
R¹ is an optionally heteroatom-containing hydrocarbon radical with up to 22 carbon atoms and
R² is a hydrocarbon radical containing at least one isocyanate group and in addition, optionally, urethane, allophanate, biuret, uretdione, isocyanurate and/or iminooxadiazinedione units and
n is an integer from 1 to 100,
and
B) optionally further, non-A) polyisocyanates containing aliphatically, cycloaliphatically, aromatically and/or araliphatically attached isocyanate groups
and
C) at least one ionic and/or nonionic emulsifier.

2. Hydrophilic polyisocyanate mixtures according to claim 1, wherein the polyacrylate-modified polyisocyanates used in component A) have an NCO content of 5% to 25% by weight and an average NCO-functionality ≧2, and a viscosity at 23° C. of 150 to 200 000 mPa·s.

3. Hydrophilic polyisocyanate mixtures according to claim 1, wherein the polyisocyanates of polyisocyanate components A) and B) contain exclusively aliphatically and/or cycloaliphatically attached isocyanate groups.

4. Hydrophilic polyisocyanate mixtures according to claim 1, wherein the emulsifier component C) comprises reaction products of polyisocyanates with monofunctional polyalkylene oxide polyether alcohols containing on average from 5 to 35 ethylene oxide units.

5. Hydrophilic polyisocyanate mixtures according to claim 1, wherein the emulsifier component C) comprises reaction products of polyisocyanate components A) and/or B) with 2-(cyclohexylamino)ethanesulphonic acid and/or 3-(cyclohexylamino)propanesulphonic acid.

6. Hydrophilicized polyisocyanates based on aromatic, araliphatic, cycloaliphatic and/or aliphatic polyisocyanates having an NCO content of 5% to 25% by weight, an NCO functionality ≧2, a viscosity in solvent-free state of 150 to 200 000 mPa·s at 23° C., containing at least one structural unit of the formula (I) 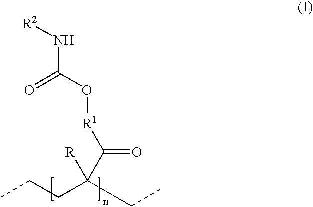
where
R is hydrogen or a methyl group,
R¹ is an optionally heteroatom-containing hydrocarbon radical with up to 22 carbon atoms and
R² is a hydrocarbon radical containing at least one isocyanate group and additionally, optionally, urethane, allophanate, biuret, uretdione, isocyanurate and/or iminooxadiazinedione units and
n is a number from 1 to 100
and additionally
polyether units of the formula (II) 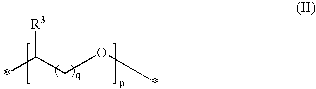
where
R³ is hydrogen or a C₁ to C₁₀ alkyl radical and
p is a number between 1 to 1000, and
q is 1 to 3
and/or sulphonate groups (as SO₃)
and/or phosphate groups (as PO₄).

7. Process for preparing hydrophilic polyisocyanate mixtures according to claim 1, wherein the polyisocyanate components A) and optionally B) is mixed with an ionic and/or nonionic emulsifier C) and/or an emulsifier of said kind is generated in situ by reacting the polyisocyanate components A) and optionally B) with hydrophilic, isocyanate-reactive ionic and/or nonionic compounds, the amounts of the starting components being chosen, irrespective of the preparation process, such that the emulsifier is present in an amount of 2% to 60% by weight, based on the total amount of components A) to C).

8. A starting component for polyurethane plastics comprising the hydrophilic polyisocyanate mixtures according to claim 1.

9. A starting component for polyurethane plastics comprising the hydrophilic polyisocyanate mixtures according to claim 6.

10. A crosslinker component for water-soluble or water-dispersible film-forming binders or film-forming binder components comprising the hydrophilic polyisocyanate mixtures according to claim 1.

11. A crosslinker component for water-soluble or water-dispersible film-forming binders or film-forming binder components comprising the hydrophilic polyisocyanate mixtures according to claim 6.

12. Coating compositions comprising hydrophilic polyisocyanates according to claim 1.

13. Coating compositions comprising hydrophilic polyisocyanates according to claim 6.

14. Substrates coated with coating compositions according to claim 12.

15. Substrates coated with coating compositions according to claim 13.
